(19) United States
(12) Patent Application Publication
(10) Pub. No.: US 2024/0361073 A1
(43) Pub. Date: Oct. 31, 2024

(54) DRYING APPARATUS AND METHOD FOR DRYING CONTAINERS CONTAINING CLEANING FLUID

(71) Applicant: BELVAC PRODUCTION MACHINERY, INC., Lynchburg, VA (US)

(72) Inventors: Ulf REINHARDT, Teutschenthal (DE); Wilko HARMS, Wittmund (DE)

(21) Appl. No.: 18/684,470

(22) PCT Filed: Jul. 11, 2022
(86) PCT No.: PCT/DE2022/100496

§ 371 Date: Feb. 16, 2024

(30) Foreign Application Priority Data
Aug. 17, 2021 (DE) 10 2021 121 346.0

(51) Int. Cl. F26B 21/00; F26B 15/18; F26B 25/00

(52) U.S. Cl. CPC F26B 21/004; F26B 15/18; F26B 21/006; F26B 25/003

(57) ABSTRACT

The invention relates to a drying apparatus for drying containers containing cleaning fluid, the drying apparatus including a fluid flow device that is arranged and designed to apply a drying fluid to the containers, said drying fluid being oriented in a direction of fluid flow, the drying apparatus also comprising including a mounting device that is arranged and designed to retain the containers in a mounted direction, the mounted direction pointing in the direction opposite the direction of fluid flow.

### CROSS-REFERENCE TO RELATED APPLICATIONS

This application is a U.S. national stage of International Application No. PCT/DE2022/100496, filed Jul. 11, 2022, which claims the benefit of and priority to German Patent Application No. 10 2021 121 346.0, filed Aug. 17, 2021, each of which are hereby incorporated by reference herein in its entirety.

### FIELD

The invention relates to a drying apparatus and a method for drying containers containing cleaning fluid.

### BACKGROUND

Drying apparatuses are generally known. The production process of containers, for example beverage cans, is characterized by several process steps. Cleaning processes are typically required between individual process steps. During the cleaning process, the cans are cleaned with a cleaning fluid. To ensure that the subsequent process step can be carried out with predefined parameters, the cans must be dried after the cleaning process.

To dry the cans, they are exposed to a drying fluid, which usually has temperatures between 100 degrees Celsius and 250 degrees Celsius. The drying fluid is supplied at a low speed of 2 meters per second to 10 meters per second so as not to affect the position of the cans. The drying fluid is usually air. The cans are usually moved through the drying apparatus with their bottom facing upwards and their opening facing downwards. The cans are usually supplied with the drying fluid from above. The drying fluid must be supplied or a fluid flow of the drying fluid must be set in such a way that the cans are not affected by the drying fluid flow, in particular that they are not tipped over or fall off the conveyor belt.

Since the weight of cans is low, the drying fluid flow must also be set so low that the influence on the cans mentioned above does not essentially take place. To ensure that the cans are nevertheless dried reliably, the drying fluid is set to a high temperature, for example 100 degrees Celsius to 250 degrees Celsius, so that the cans can be dried even with the low drying fluid flow.

This high temperature of the drying fluid leads to high energy consumption, as the drying fluid has to be heated to this high temperature. In addition, such high temperatures of the drying fluid are usually achieved with a gas burner, whereby the amount of CO2 produced is disadvantageous.

This high temperature also meant that a plurality of materials could not be used in the drying apparatus as they are not temperature-resistant. For example, simpler plastics, which regularly lose their predefined material properties above 90 degrees, cannot be used. As a result, mechanisms known from other can manufacturing processes in particular, for example from upstream or downstream machines, could not be transferred to the drying apparatus.

It is a demand from the industry that can production is energy-efficient. In addition, the consumption of conventional energy sources, such as gas, should be reduced. In general, the industry is striving to improve the ecological footprint per can produced.

It is therefore a task of the invention to provide a drying apparatus and a method for drying containers containing cleaning fluid, which reduce or eliminate one or more of the aforementioned disadvantages. In particular, it is a task of the invention to provide a solution which enables more efficient drying of containers containing cleaning fluid.

This task is solved with an apparatus and a method according to the features of the independent claims. Further advantageous embodiments of these aspects are indicated in the respective dependent claims. The features individually set out in the claims and the description are mutually combinable in any technically useful manner, wherein further embodiments of the invention are revealed.

### SUMMARY

According to one embodiment, a drying apparatus for drying containers including cleaning fluid is disclosed. The apparatus comprises a fluid flow device arranged and designed to apply a drying fluid directed in a direction of fluid flow to the containers. The apparatus further comprises a mounting device arranged and designed to retain the containers in a mounted direction. The mounted direction is aligned in the direction opposite to the direction of fluid flow.

According to another embodiment, a method of drying containers including cleaning fluid is disclosed. The method comprises applying a drying fluid oriented in a direction of fluid flow to the containers. The method further comprises retaining the containers in a mounted direction. The mounted direction is aligned in the direction opposite to the direction of fluid flow.

### BRIEF DESCRIPTION OF THE DRAWINGS

Preferred embodiments are explained by way of example with reference to the enclosed figures. It shows in:

FIG. 1: a schematic two-dimensional view of an exemplary embodiment of a drying apparatus;

FIG. 2: a further schematic, two-dimensional view of a further exemplary embodiment of a drying apparatus;

FIG. 3: a further schematic, two-dimensional view of a further exemplary embodiment of a drying apparatus;

FIG. 4: a further schematic, two-dimensional view of a further exemplary embodiment of a drying apparatus; and

FIG. 5: a schematic view of an exemplary embodiment of a method.

In the figures, identical or essentially functionally identical or similar elements are designated with the same reference numerals.

### DETAILED DESCRIPTION

According to a first aspect, the task mentioned at the beginning is solved by a drying apparatus for drying containers containing cleaning fluid, said drying apparatus comprising a fluid flow device which is arranged and designed to apply a drying fluid to the containers, said drying fluid being oriented in a direction of fluid flow, the drying apparatus also comprising a mounting device which is arranged and designed to retain the containers in a mounted direction, whereby the mounted direction is oriented in the direction opposite to the direction of fluid flow.

The invention is based on the finding that the cans can be positioned on a conveyor device by means of a mounting device and, in particular, are not undesirably moved by the application of the drying fluid. This prevents the cans from falling over and/or falling down, and reduces waste.

A further finding of the invention is that the fluid flow of the drying fluid can be increased by means of this mounting device, as the containers are held down securely. By increasing the fluid flow of the drying fluid, the temperature of the drying fluid can be lowered. By lowering the temperature of the drying fluid, the energy consumption of the drying apparatus is reduced. Thus, the containers can advantageously be dried at a temperature below 100° C. In addition, it has been found that energy savings of between 25% and 40% can be achieved.

Another advantage is that the containers can be exposed to the drying fluid from the inside and outside, meaning that the containers can be dried more quickly, safely and efficiently.

The lower temperature of the drying fluid also means that simpler and therefore cheaper materials can be used, for example for a conveyor belt. In addition, the inventors have found that the drying as such is of a higher quality and that on average there is less cleaning fluid on the containers at the outlet of the drying apparatus.

In addition, the mounting device enables the use of alternative heat sources. For example, the exhaust air from upstream and/or downstream machines can be used as a drying fluid or to heat up the drying fluid. In addition, the drying fluid can be heated with an electric heating device.

The fluid flow device is to be understood in particular as a device that provides the drying fluid. In particular, the drying fluid is provided in such a way that a main flow direction of the drying fluid corresponds to the direction of fluid flow. For a person skilled in the art, it is self-evident that a drying fluid provided in a drying apparatus does not perform exclusively linear movements and thus other directions of the drying fluid can be determined in addition to the direction of fluid flow. The direction of fluid flow is therefore to be understood in particular as a main direction of fluid flow. This can be achieved, for example, with a nozzle unit with a plurality of fluid flow outlets, which is explained in more detail below, whereby the fluid flow outlets are aligned in the direction of the fluid flow.

The mounting device is arranged and designed to retain the containers in a mounted direction. The containers are usually moved in a horizontal direction by the drying apparatus. In particular, the mounting device can be arranged vertically above the containers so that they cannot be moved vertically upwards. For example, the containers can be held down by resting the mounting device on the bottom of the container.

As explained in more detail below, the mounting device can, for example, be arranged vertically above a conveyor device, such as a conveyor belt, so that the containers are clamped between the conveyor device and the mounting device and are moved by a synchronous movement of the mounting device and the conveyor device held down by the drying apparatus.

The mounted direction is aligned in the direction opposite to the direction of fluid flow. In particular, this means that an angle between the mounted direction and the direction of fluid flow is less than 30 degrees, less than 20 degrees, less than 10 degrees, less than 5 degrees or less than 2.5 degrees.

Without the mounting device, the drying fluid can cause the containers to move in the direction of the fluid flow. These could, for example, move vertically upwards due to the drying fluid. The mounting device holds the containers down in the mounted direction. As the mounted direction is aligned in the direction opposite to the direction of fluid flow, secure positioning of the containers is guaranteed. As a result, the advantages mentioned above are made possible by this drying apparatus.

A preferred embodiment of the drying apparatus is characterized by the fact that the direction of fluid flow can be aligned in the same direction as the mounted direction. For example, the fluid flow device can be controlled in such a way that the drying fluid is applied to the containers from bottom to top in a first area and from top to bottom in a second area. Among other things, this can be preferable in order to remove cleaning fluid from a concave section, for example a container base. Furthermore, the containers can advantageously be supplied with the drying fluid from the outside and from the inside.

A preferred embodiment of the drying apparatus is characterized by the fact that, during intended operation, the direction of fluid flow is oriented vertically upwards and the mounting direction is oriented vertically downwards.

A vertically upwardly or vertically downwardly oriented direction of fluid flow or mounted direction means in particular that the direction of fluid flow and/or the mounted direction encloses an angle with a vertical which is less than 30 degrees, less than 20 degrees, less than 10 degrees, less than 5 degrees or less than 2.5 degrees. Alternatively, the drying apparatus can be designed mirrored in a horizontal plane so that the direction of fluid flow is vertically downwards and the mounted direction is vertically upwards.

A further preferred embodiment of the drying apparatus comprises a conveyor section extending from a conveyor start point to a conveyor end point and a conveyor unit which is arranged and designed to move the containers at least in sections along the conveyor section, wherein the mounting device is further arranged and designed to retain the containers at least in sections along the conveyor section.

It is possible, for example, that the fluid flow device only applies the drying fluid to the containers in one section of the conveyor section. In this case, it is preferable that the mounting device only holds down the containers in this section. This allows the mounting device to be as small as possible and saves energy.

In a further preferred embodiment of the drying apparatus, it is provided that the mounting device is further arranged and designed to move the containers at least in sections along the conveyor section.

For this purpose, the mounting device can, for example, be arranged and designed to form a connection with the containers. For this purpose, for example, a force-fit connection can be formed between the mounting device and the containers. This can be done using the vacuum described in more detail below.

A mounting device arranged and designed in this way has the advantage that the containers are also moved by the mounting device and not exclusively by the conveyor unit. Thus, autonomous movement of the containers is possible exclusively by means of the mounting device.

A further preferred embodiment of the drying apparatus is characterized in that the mounting device is further arranged and designed in such a way that a mounting force can be adjusted in the mounted direction on the containers.

An adjustable mounting force can, for example, take into account different fluid flows of the drying fluid. In addition, different container properties can be taken into account. For example, a container made of steel requires a lower holding force than a container made of aluminum. The mounting device can have a spring unit, for example, for adjusting the mounting force.

In a further preferred embodiment of the drying apparatus, it is further provided that the containers can be clamped at least in sections between the conveyor unit and the mounting device. For this purpose, the conveyor unit and the mounting device are arranged in such a way that containers can be placed between them.

It is particularly preferred that a vertical distance between the mounting device and the conveyor unit can be adjusted. This makes it possible, for example, for the distance between the conveyor unit and the mounting device to essentially correspond to a container height of the containers.

In a further preferred embodiment of the drying apparatus, it is provided that the conveyor unit has a conveyor belt and the mounting device has a mounting belt aligned parallel to the conveyor belt, and the conveyor belt and the mounting belt are arranged to be movable parallel to one another. The conveyor belt and the mounting belt can also partially sag along the conveyor section, so that a certain deviation from an ideal parallelism is natural for the person skilled in the art.

The parallel movement of the conveyor belt and the mounting belt relates in particular to the sections of the conveyor belt and the mounting belt that are in contact with the containers during intended operation and/or are arranged facing each other. Of course, the conveyor belt and the mounting belt have return sections and also return sections, the orientation of which is essentially irrelevant for drying the containers.

It is particularly preferred that the conveyor belt and the mounting belt can be moved synchronously with each other. Synchronous movement allows containers clamped between the conveyor belt and the mounting belt to be moved in an optimum manner.

A further preferred embodiment of the drying apparatus is characterized by the fact that the conveyor belt and/or the mounting belt is/are fluid-permeable. The conveyor belt and/or the mounting belt can, for example, have a net-like design. A fluid permeability of the conveyor belt and/or the mounting belt enables an improved drying process of the containers and, in addition, the formation of a vacuum, which is explained in more detail below.

A further preferred embodiment of the drying apparatus is characterized in that the conveyor unit has, at least in sections along the conveyor section, a free section in which the conveyor unit is interrupted, and the mounting device is arranged and designed to cause a vacuum on the containers, so that the containers in the free section can be moved by the mounting device.

In particular, the mounting device is arranged vertically above the conveyor unit. In the free section, the containers are suspended from the mounting device and are moved in the direction of the conveyor section by the movement of the mounting device. In the free section, the containers can be moved by the mounting device, in particular without the conveyor unit.

A further preferred embodiment of the drying apparatus comprises a vacuum unit for effecting the vacuum on the containers, wherein the vacuum unit is arranged and designed to effect the vacuum between a mounting upper run and a mounting lower run of the mounting belt.

The lower run of the mounting belt is in particular the load-bearing run of the mounting belt, so that it is in particular preferred that the vacuum is provided by the vacuum unit in such a way that the containers are sucked onto the mounting lower run by the vacuum.

Another preferred embodiment of the drying apparatus comprises a drying chamber in which the containers can be exposed to the drying fluid, with the free section extending from an inlet end to an outlet end of the drying chamber. The inlet end is the end of the drying chamber through which the containers can enter the drying chamber. The outlet end of the drying chamber is the end through which the containers exit the drying chamber.

This embodiment means that the containers inside the drying chamber are essentially moved along the conveyor section by the mounting device. The ends of the containers facing away from the mounting device are the open ends, so that they are completely exposed to the drying fluid and no conveyor unit or conveyor belt, for example, influences the fluid flow of the drying fluid. This enables better drying of the containers.

A further preferred embodiment of the drying apparatus comprises at least one nozzle unit for applying the drying fluid to the containers, wherein the conveyor belt has an conveyor upper run and a conveyor lower run and at least one fluid flow outlet of the nozzle unit is arranged between the conveyor upper run and the conveyor lower run. The nozzle unit can be included in the fluid flow device. A fluid flow outlet arranged in this way is less influenced by the conveyor belt, since the fluid flow of the drying fluid only passes through a single run and not through two runs. It is particularly preferred that the conveyor upper run is the load-bearing run.

It is furthermore preferred that the nozzle unit is arranged and designed to pressurize the cavities of the containers with the drying fluid in such a way that an inlet fluid flow enters the cavities and an outlet fluid flow of the drying fluid exits the cavities.

The inlet fluid flow and outlet fluid flow result in the drying fluid advantageously being able to act in the cavities of the containers, so that these are advantageously dried. It is particularly preferred that the at least one fluid outlet is designed in such a way that the fluid flow is jet-shaped.

It is also preferable that the fluid flow is not flat. In particular, with a jet diameter that is many times smaller than a typical container diameter, advantageous drying can be achieved with an inlet fluid flow and an outlet fluid flow.

In a further preferred embodiment of the drying apparatus, it is provided that the drying apparatus comprises a fluid detection unit arranged and designed to detect the cleaning fluid, in particular an amount of the cleaning fluid. In addition, it is preferred that the fluid detection device has a further vacuum unit which is arranged and designed to effect a vacuum on a container base of the containers, and the fluid detection unit is arranged such that the cavities of the containers face it. With a fluid detection device designed in this way, it is advantageously possible to detect whether cleaning fluid is still present in the cavities of the containers. As a result, the quality of the drying process can be checked.

According to a further aspect, the above-mentioned object is solved by a method for drying containers containing cleaning fluid, comprising the steps: applying to the containers a drying fluid oriented in a direction of fluid flow, and mounting the containers in a mounted direction, whereby the mounted direction is oriented in the direction opposite to the direction of fluid flow.

The method and its possible further developments have features and/or method steps which make them particularly suitable for being used for a drying apparatus and its further developments. For further advantages, embodiments and design details of the further aspects and their possible further developments, reference is also made to the prior description of the corresponding features and further developments of the drying apparatus.

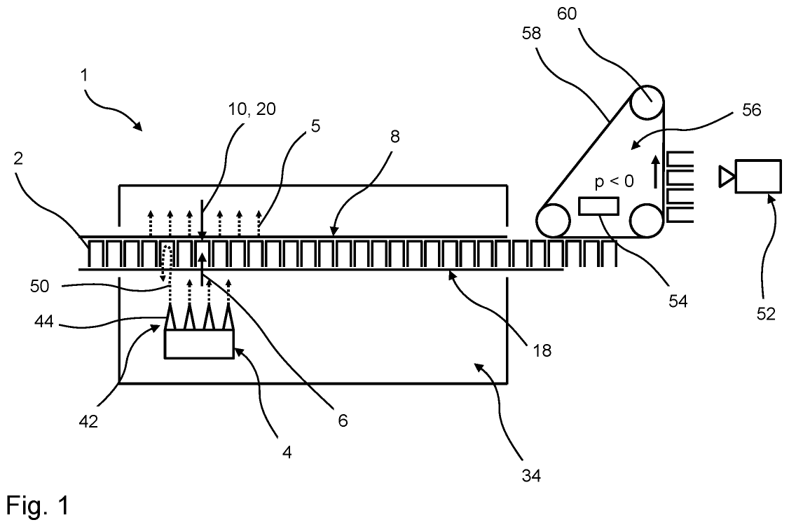

FIG. 1 shows a drying apparatus 1 for drying containers 2 containing cleaning fluid. In an upstream process step, the containers 2 can be cleaned with a cleaning apparatus specially designed for containers, also known as a washer. This removes oils, among other things.

The drying apparatus 1 comprises a fluid flow device 4, which is arranged and designed to apply a drying fluid directed in a direction of fluid flow 6 to the containers 2. The direction of fluid flow 6 is oriented vertically upwards. The containers 2 are subjected to a vertically upwardly oriented force by the direction of fluid flow 6. This force results in the containers 2 being moved vertically upwards without the mounting device 8 described below and thus tipping over and/or being moved away from the conveyor unit 18, for example falling down.

The fluid flow device 4 comprises a nozzle unit 42 with a plurality of fluid flow units 44, which can generate a fluid flow with a defined geometry. It is particularly preferred that the geometry of the fluid flow is jet-shaped, so that the inlet and outlet fluid flow 50 is generated in the containers 2, so that these are advantageously dried.

In addition, the drying apparatus comprises the conveyor unit 18, with which the containers are moved from the left side to the right side of the drying apparatus. The mounting device 8 is provided vertically above and at a distance from the conveyor unit 18.

The mounting device 8 is arranged and designed to retain the containers 2 in a mounted direction 10. The mounting direction 10 is oriented in the direction opposite to the direction of fluid flow 6, so that the containers 2 remain essentially unmoved by the force in the direction of fluid flow 6, since the force 20 of the mounting device 8 in the mounting direction 10 counteracts this force. The conveyor unit 18 and the mounting device 8 are essentially fluid-permeable, so that a fluid flow 5 can pass through them. The fluid flows are each shown with dashed lines.

The containers 2 can now be subjected to a stronger fluid flow 5 without them leaving their defined position, as they are held down by the mounting device 8. As a result, the temperature of the drying fluid can be reduced. This improves the energy efficiency of the drying apparatus 1. In addition, primary energy sources, such as gas, can be saved.

A fluid detection device 52 is also provided at the outlet of the drying apparatus 1. Furthermore, a conveyor belt 58 with deflection rollers 60 is provided here. A vacuum chamber 56 is formed within the conveyor belt 58 by means of a vacuum unit 54. A vacuum can be exerted on the containers 2 through the vacuum chamber 56 by the conveyor belt 58, so that these can be taken over by the conveyor unit 18. The fluid detection device 52, which may be a camera, for example, is arranged such that it analyzes the cavities of the containers 2 in order to detect any remaining cleaning fluid in the containers 2.

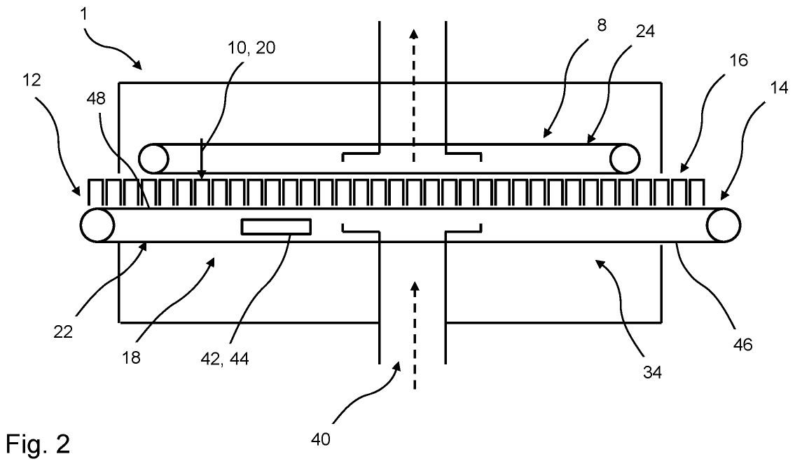

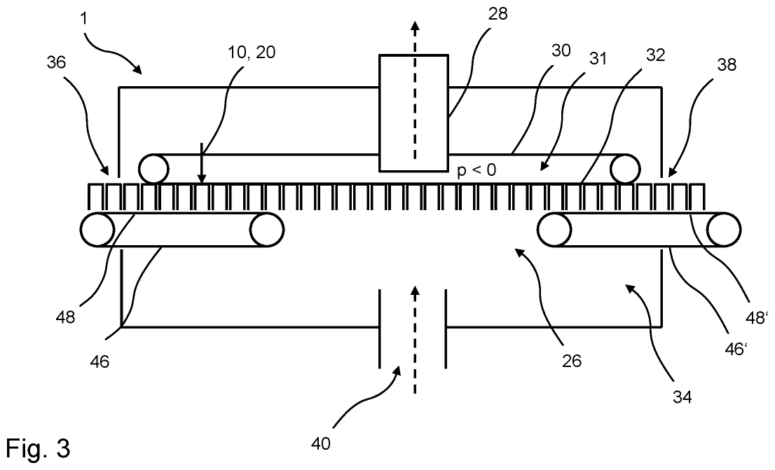

FIGS. 2 to 4 show different embodiments of the drying apparatus 1, whereby the reference numerals are not repeated in full in each case for improved illustration. The drying apparatus 1 has a conveyor section 16 extending from a conveyor start point 12 to a conveyor end point 14.

The mounting device 8 has a mounting belt 24 which comprises an mounting upper run 30 and a mounting lower run 32. A mounting vacuum chamber 31 is formed by the holding mounting run 30 and the mounting lower run 32, so that a vacuum can be formed between the runs 30, 32. A vacuum unit 28 is provided for this purpose. The containers 2 are sucked towards the mounting lower run 32 by the vacuum, so that in a free section 26 the containers 2 are conveyed exclusively by the mounting device and not by the conveyor unit 18.

The conveyor unit 18 here is formed in two parts and comprises two conveyor belts 22. Each of the conveyor belts comprises an upper run 48, 48′, and a conveyor lower run 46, 46′. This embodiment has the advantage that the containers 2 are advantageously dried within the drying chamber 34, since no conveyor unit 18 is arranged vertically below the containers 2, which influences the fluid flow of the drying fluid. The drying fluid entering the drying chamber 34 through the fluid feed 40 thus reaches the containers 2 directly.

FIG. 2 also shows that the nozzle unit 42 with the plurality of fluid flow units 44 can be arranged between the conveyor lower run 46 and the conveyor upper run 48, so that the containers 2 can advantageously be acted upon.

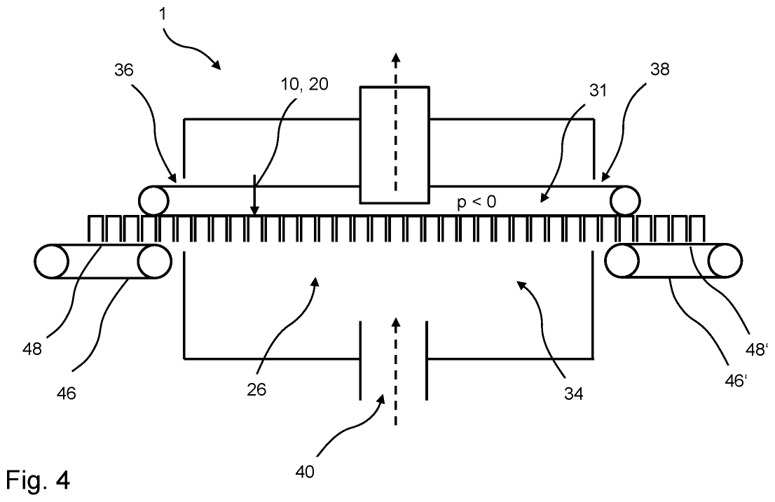

The drying chamber 34 extends from an inlet end 36 to an outlet end 38. FIG. 4 shows that the free section 26 extends from the inlet end 36 to the outlet end 38. The conveyor unit 18 thus acts in particular outside the drying chamber 34. This embodiment variant enables optimum drying of the containers 2, since the conveyor unit 18 essentially does not influence the fluid flow of the drying fluid.

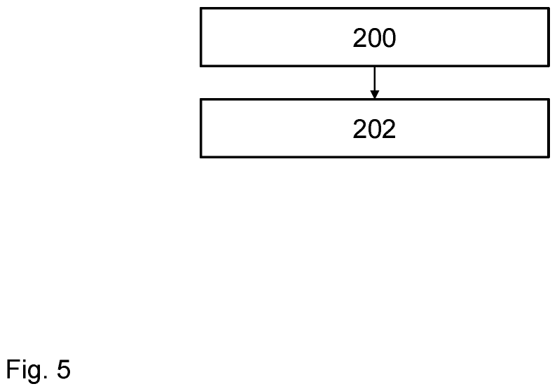

FIG. 5 shows a schematic view of an exemplary process. In step 200, the containers 2 are acted upon by a drying fluid oriented in a direction of fluid flow 6. To ensure that the containers 2 remain in their position, the containers are held down in a mounted direction 10. The mounted direction 10 and the direction of fluid flow 6 are aligned in opposite directions.

The drying apparatus 1 and the corresponding method described above have the advantage that the containers 2 remain in their position even if they are subjected to a strong fluid flow of the drying fluid. This makes it possible to increase the fluid flow of the drying fluid and at the same time reduce the temperature of the drying fluid. The energy consumption of the drying apparatus 1 is thus reduced and the consumption of primary energy sources, in particular gas, is reduced. In addition, it is possible to provide the conveyor belt 22 and also the mounting belt 24 from a material that is only designed for low temperatures. This makes the drying apparatus 1 more cost-effective.

1. A drying apparatus for drying containers including cleaning fluid, the apparatus comprising:
a fluid flow device arranged and designed to apply a drying fluid directed in a direction of fluid flow to the containers; and
a mounting device arranged and designed to retain the containers in a mounted direction,
whereby the mounted direction is aligned in the direction opposite to the direction of fluid flow.

2. The drying apparatus according to claim 1, wherein the direction of fluid flow is configured to be aligned in the same direction as the mounting direction.

3. The drying apparatus according to claim 1, wherein in the intended operation, the direction of fluid flow is oriented vertically upwards and the mounting direction is oriented vertically downwards.

4. The drying apparatus according to claim 1, the apparatus further comprising:
a conveyor section extending from a conveyor start point to a conveyor end point; and
a conveyor unit arranged and designed to move the containers at least in sections along the conveyor section,
whereby the mounting device is further arranged and designed to retain the containers at least in sections along the conveyor section.

5. The drying apparatus according to claim 1, wherein the mounting device is further arranged and designed to move the containers at least in sections along the conveyor section.

6. The drying apparatus according to claim 1, wherein the mounting device is further arranged and designed such that a mounting force is adjustable on the containers in the mounting direction.

7. The drying apparatus according to claim 1, wherein the containers can be clamped at least in sections between the conveyor unit and the mounting device.

8. The drying apparatus according to claim 1, wherein
the conveyor unit comprises a conveyor belt, and the mounting device comprises a mounting belt aligned parallel to the conveyor belt, and
the conveyor belt and the mounting belt are arranged movably parallel to each other.

9. The drying apparatus according to claim 1, wherein at least one of the conveyor belt and the mounting belt is fluid-permeable.

10. The drying apparatus according to claim 1, wherein
the conveyor unit has a free section, at least in sections along the conveyor section, in which the conveyor unit is interrupted, and
the mounting device is arranged and designed to affect a vacuum on the containers, so that the containers can be moved by the mounting device in the free section.

11. The drying apparatus according to claim 1, the apparatus further comprising a vacuum unit for effecting the vacuum on the containers,
whereby the vacuum unit is arranged and designed to affect the vacuum between a mounting upper run and a mounting lower run of the mounting belt.

12. The drying apparatus according to claim 1, the apparatus further comprising a drying chamber in which the drying fluid can be applied to the containers,
whereby the free section extends from an inlet end to an outlet end of the drying chamber.

13. The drying apparatus according to claim 1, the apparatus further comprising at least one nozzle unit for applying the drying fluid to the containers,
wherein the conveyor belt has a conveyor upper run and a conveyor lower run, and at least one fluid flow outlet of the nozzle unit is arranged between the conveyor upper run and the conveyor lower run.

14. The drying apparatus according to claim 1, wherein the nozzle unit is arranged and designed to pressurize the cavities of the containers with the drying fluid in such a way that an inlet fluid flow enters the cavities, and an outlet fluid flow of the drying fluid exits the cavities.

15. The drying apparatus according to claim 1, wherein at least one fluid outlet is designed in such a way that the fluid flow is jet-shaped.

16. A method of drying containers including cleaning fluid, the method comprising:
applying a drying fluid oriented in a direction of fluid flow to the containers; and
retaining the containers in a mounted direction,
whereby the mounted direction is aligned in the direction opposite to the direction of fluid flow.
